(19) United States
(12) Patent Application Publication
(10) Pub. No.: US 2016/0112699 A1
(43) Pub. Date: Apr. 21, 2016

(54) TESTING CHART, CAMERA MODULE TESTING SYSTEM AND CAMERA MODULE TESTING METHOD

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: YU-TSANG TU, New Taipei (TW); TIAN-YOU XIE, Shenzhen (CN)

(21) Appl. No.: 14/865,327

(22) Filed: Sep. 25, 2015

(30) Foreign Application Priority Data
Oct. 21, 2014 (CN) 201410573040.5

(51) Int. Cl. H04N 17/00; H04N 5/232; H04N 5/225; H04N 17/02

(52) U.S. Cl. CPC H04N 17/002; H04N 17/02; H04N 5/232; H04N 5/2254

(57) ABSTRACT

The present disclosure relates to a camera module testing method, the camera module testing method includes following steps: providing a testing chart, wherein the testing chart includes a scaleboard and at least four marks distributed on the scaleboard, each quadrant of a rectangular coordinate system with an origin thereof meeting a geometric center of the testing chart is distributed with at least one of the marks; providing a camera module for capturing an image of the testing chart, wherein the camera module includes a voice coil motor; providing a processor, the processor can generate a movement distance and a horizontal offset of the voice coil motor according to the image captured by the camera module and the location of the at least four marks. The disclosure also relates to a testing chart and a camera module testing system using the testing chart.

### FIELD

The present disclosure relates to a field of camera modules tests, and particularly relates to a testing chart configured to test a camera module, system and method for testing a camera module using the testing chart.

### BACKGROUND

Voice coil motors are usually used to drive a focusing lens of a camera module. After assembly, the camera module is tested under some conditions to ensure that the voice coil motor has a desirable performance Currently, the test of the camera module is commonly performed by a specific laser distance meter.

### BRIEF DESCRIPTION OF THE DRAWINGS

Implementations of the present technology will now be described, by way of example only, with reference to the attached figures, wherein:

FIG. 1 is a planar view of an embodiment of a testing chart of the disclosure.

FIG. 2 is a diagrammatic view of a method for testing a camera module using the testing chart of FIG. 1.

FIG. 3 is a cross sectional view of the camera module of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

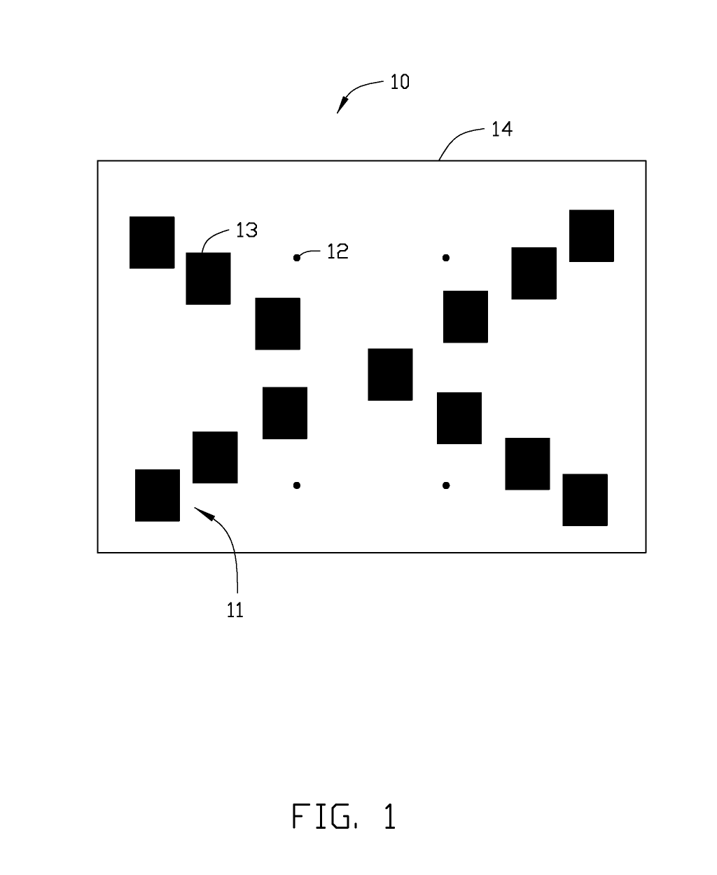

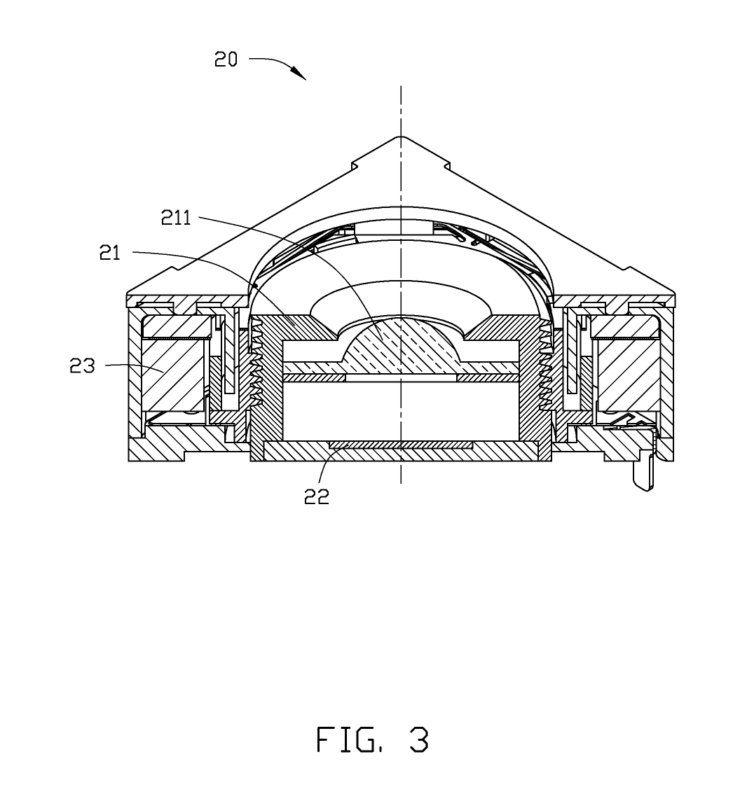

FIGS. 1-3 illustrate an embodiment of a camera module testing method of the present disclosure. The camera module testing method includes the following steps.

First, a testing chart 10 is provided. The testing chart 10 includes a scaleboard 14, at least four marks 12 distributed on the scaleboard 14, each quadrant of a rectangular coordinate system with an origin thereof meeting a geometric center of the testing chart 10 is distributed with at least one of the marks 12. The marks 12 are distributed along a polygon, and each mark 12 meets a vertex of the polygon. A geometric center of the polygon meets the geometric center of the testing chart 10.

In at least one embodiment, the number of the marks 12 is four, and the polygon formed by the marks 12 is substantially a rectangle. The four marks 12 are substantially circular-shaped. The testing chart 10 also includes a testing pattern 11 printed on the scaleboard 14, the testing pattern 11 is formed by a number of colored areas 13. A shape of each of the marks 12 is different from that of the colored area 13. In the embodiment, the colored areas 13 are black, and each colored area 13 is substantially rectangular-shaped. Alternatively, the colored areas 13 can be other colors.

The shapes and sizes of the marks 12 and the shapes and sizes of the testing patterns 11 are not limited to the embodiment, as long as the marks 12 and the colored areas 13 can be easily indentified. In other embodiments, the marks 12 can be other shapes, such as square, trapezium, and rhombus; the color areas 13 also can be other shapes, such as rotundity, trapezium, and rhombus. Of course, the shapes of the marks 12 can be the same as the shapes of the colored areas 13. The colored areas 13 and the marks 12 are separated from each other, in other words, the colored areas 13 are separated from the marks 12 on the testing chart 10.

Next step, a camera module 20 is provided. The camera module 20 is configured to capture an image of the testing chart 10. The camera module 20 includes a lens assembly 21 and a voice coil motor 23. The lens assembly 21 includes a focusing lens 211, the voice coil motor 23 is configured to drive the focusing lens 211 to move along an optical axis of the camera module 20. The camera module 20 also includes an image sensor 22 aligned with the focusing lens 211 along the optical axis of the camera module 20. The geometric center of the polygon formed by the marks 12 and an image sensing center of the camera module 20 both on the optical axis. The voice coil motor 23 can drive the focusing lens 211 to different positions according to different input voltage and/or current.

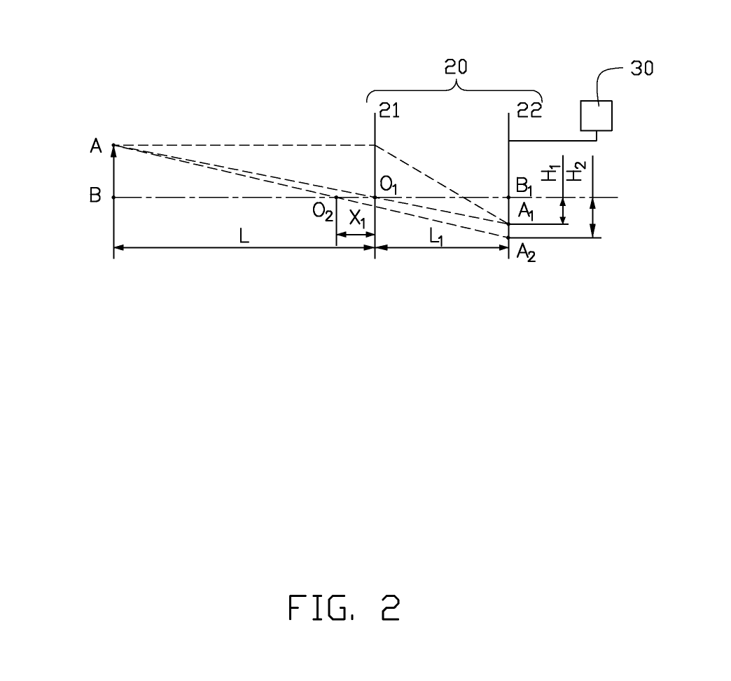

Referring to FIG. 2, the testing chart 10 is at position AB, a height H of the testing chart 10 at a direction of the AB is 138.0964 mm, the height H is equal to a distance between the position A and the position B, and an object distance L is 300 mm. An image height H₁ of the image captured by the camera module 20 when the focusing lens 211 is located at position O₁ and an image height H₂ of the image captured by the camera module 20 when the focusing lens 211 is located at position O₂ can be gained by a corresponding image. According to geometrical principle, triangle ABO₁ and triangle A₁B₁O₁ are similar triangles, so the triangle ABO₁ and the triangle A₁B₁O₁ satisfy a formula: H/L=H₁/L₁, wherein L₁ is L₁=H₁L/H; triangle ABO₂ and triangle A₂B₁O₂ are similar triangles, thereby H/(L−X₁)=H₂/(L₁+X₁), a movement distance X₁=(H₂L−HL₁)/(H+H₂). According to the images captured by the camera module 20, a movement distance X₁ of the voice coil motor 23 at different drive current can be acquired. The L₁ is the object distance when the focusing lens 211 is located at position O₁.

In a next step, a processor 30 is provided. The processor 30 and the image sensor 22 are electrically connected to each other. During a focusing process of the camera module 20, the processor 30 determines a horizontal driving offset of the voice coil motor 23 according to a position of the polygon formed by the marks 12 relative to the image sensing center of the camera module 20. According to an offset value of the a geometric center of the polygon formed by the marks 12 relative to the image sensing center of the camera module 20, the processor 30 calculates a value of the horizontal driving offset of the voice coil motor 23. According to a direction of the offset of the geometric center of the polygon formed by the marks 12 relative to the image sensing center of the camera module 20, the processor 30 calculates a direction of the horizontal driving offset. Under normal circumstances, the geometric center of the polygon formed by the images of the four marks 12 meets the image sensing center of the camera module 20. However, when the voice coil motor 23 generates an offset, the geometric center of the polygon formed by the images of the four marks 12 generates an offset or a tilt along X axis and/or Y axis of a rectangular coordinate system with an origin thereof located in central axis of the processor 30. The rectangular coordinate system substantially perpendicular to the central axis of the focusing lens 211, so the processor 30 can determine the offset along the X axis and the offset along the Y axis of the voice coil motor 23 according to the position of the polygon formed by the images of the four marks 12. There are actual movement distance X₂, movement distance as measured X₁, the offset along the X axis and the offset along the Y axis can be found in a Table 1.

TABLE 1

| | Actual | Movement | Horizontal offset | |
|---|---|---|---|---|
| Driving | movement | distance as | Offset along | Offset along |
| current | distance X₂ | measured X₁ | the X axis | the Y axis |
| (mA) | (um) | (um) | (degree) | (degree) |
| −48.571 | −240.576 | −237.477 | 0.011396 | 0.024141 |
| −47.619 | −237.408 | −234.312 | −0.01047 | 0.045753 |
| −46.667 | −237.408 | −234.312 | −0.01047 | 0.045753 |
| −45.714 | −231.072 | −231.103 | 0.011396 | 0.024141 |
| −44.762 | −227.907 | −224.764 | 0.011396 | 0.045753 |
| −43.81 | −221.570 | −218.431 | 0.011396 | 0.067365 |
| −41.905 | −208.933 | −212.092 | 0.011396 | 0.045753 |
| −40.952 | −205.765 | −208.965 | 0.033257 | 0.024141 |
| −38.095 | −189.924 | −186.755 | 0.011396 | 0.024141 |
| −37.143 | −183.559 | −183.584 | 0.033257 | 0.045753 |
| −36.19 | −177.224 | −177.29 | 0.033257 | 0.067365 |
| −35.238 | −174.057 | −170.956 | 0.033257 | 0.067365 |
| −32.381 | −161.420 | −158.249 | 0.033257 | 0.002529 |
| −31.429 | −155.087 | −155.082 | 0.011396 | 0.002529 |
| −30.476 | −151.887 | −148.752 | 0.011396 | 0.024141 |
| −29.524 | −142.424 | −139.292 | −0.01047 | 0.002529 |
| −28.571 | −139.224 | −136.123 | 0.011396 | 0.024141 |
| −26.667 | −126.556 | −129.754 | 0.011396 | 0.024141 |
| −25.714 | −126.556 | −123.419 | 0.011396 | 0.045753 |
| −24.762 | −120.227 | −120.208 | −0.01047 | 0.024141 |
| −23.81 | −117.058 | −113.88 | 0.033257 | 0.045753 |
| −20 | −98.097 | −98.0935 | 0.011396 | 0.002529 |
| −19.048 | −94.899 | −94.928 | −0.01047 | 0.002529 |
| −18.095 | −85.404 | −85.436 | 0.011396 | 0.024141 |
| −17.143 | −82.120 | −79.1025 | 0.011396 | 0.045753 |
| −14.286 | −69.611 | −72.775 | 0.011396 | 0.024141 |
| −13.333 | −60.117 | −63.278 | −0.01047 | 0.002529 |
| −12.381 | −56.952 | −53.7843 | 0.011396 | 0.002529 |
| −10.476 | −50.591 | −47.4552 | 0.011396 | 0.002529 |
| −9.524 | −47.426 | −47.4552 | 0.011396 | 0.002529 |
| −8.571 | −47.426 | −44.2908 | −0.01047 | 0.002529 |
| −7.619 | −34.731 | −37.9186 | −0.01047 | 0.024141 |
| −4.762 | −22.145 | −19.0193 | −0.01047 | 0.002529 |
| −3.81 | −15.786 | −12.6921 | −0.01047 | 0.002529 |
| −2.857 | −15.786 | −12.6921 | −0.01047 | 0.002529 |
| −1.905 | −12.622 | −9.44696 | 0.011396 | −0.0407 |
| −0.952 | −9.458 | −9.44696 | 0.011396 | −0.0407 |
| 0 | 0 | 0 | 0.033257 | −0.01908 |
| +0.952 | +6.327 | 9.492566 | −0.03233 | 0.002529 |
| +3.81 | +19.011 | 19.02515 | −0.01047 | −0.01908 |
| +4.762 | +22.174 | 25.351 | −0.01047 | −0.01908 |
| +5.714 | +22.142 | 28.4675 | 0.011396 | −0.01908 |
| +6.667 | +28.497 | 28.4675 | 0.011396 | −0.01908 |
| +7.619 | +31.660 | 31.63324 | −0.01047 | 0.002529 |
| +8.571 | +37.987 | 37.95825 | −0.01047 | 0.002529 |
| +13.333 | +60.158 | 63.25669 | −0.01047 | 0.002529 |
| +15.238 | +66.485 | 66.46142 | 0.011396 | −0.01908 |
| +16.19 | +75.970 | 72.78515 | −0.03233 | −0.01908 |
| +17.143 | +75.934 | 75.90431 | −0.01047 | −0.0407 |
| +18.095 | +79.132 | 82.22489 | −0.01047 | −0.01908 |
| +19.048 | +85.453 | 88.55111 | −0.01047 | 0.002529 |
| +20 | +91.778 | 91.67582 | 0.011396 | −0.01908 |
| +20.952 | +98.064 | 98.0324 | −0.03233 | −0.01908 |
| +22.857 | +104.356 | 104.397 | 0.011396 | −0.0407 |
| +23.81 | +104.356 | 107.5583 | −0.01047 | −0.0407 |
| +24.762 | +113.870 | 110.6799 | −0.03233 | −0.0407 |
| +25.714 | +113.867 | 116.9991 | 0.011396 | −0.01908 |
| +26.667 | +120.189 | 123.3207 | −0.03233 | −0.01908 |
| +27.619 | +123.353 | 126.5235 | −0.05419 | −0.0407 |
| +28.571 | +129.643 | 132.8447 | −0.05419 | −0.0407 |
| +31.429 | +142.316 | 142.287 | 0.011396 | −0.0407 |
| +32.381 | +142.313 | 145.4475 | −0.01047 | −0.0407 |
| +33.333 | +148.637 | 151.8065 | −0.01047 | −0.0407 |
| +34.286 | +151.797 | 151.8092 | −0.05419 | −0.01908 |
| +35.238 | +161.247 | 158.1266 | −0.01047 | −0.0407 |
| +36.19 | +161.313 | 161.2453 | −0.03233 | −0.06231 |
| +37.143 | +164.473 | 167.5679 | −0.07605 | −0.0407 |
| +39.048 | +180.269 | 177.0858 | −0.01047 | −0.0407 |
| +40 | +180.269 | 183.4076 | −0.01047 | −0.01908 |

In Table 1, the “−” and “+” express two opposite directions.

Compare and analysis the actual movement distance X₂ and the movement distance X₁ by measure, the absolute value of the difference between the actual movement distance X₂ and the movement distance X₁ is less than 3.2 um, it is visible that the camera module testing method of the present disclosure can determines a horizontal offset of the voice coil motor 23 of the camera module 20 accurately.

A camera module testing system configured to test focusing accuracy of a camera module. The camera module testing system includes a testing chart 10, a camera module 20 and a processor 30, wherein the testing chart 10 includes a scaleboard 14, a testing pattern 11 printed on the scaleboard 14 and at least four marks 12 distributed on the scaleboard 14, the scaleboard 14 can be a paper or a film. The testing pattern 11 is formed by a number of colored areas 13. each quadrant of a rectangular coordinate system with an origin thereof meeting a geometric center of the testing chart 10 is distributed with at least one of the marks 12. The testing chart 10 is located in taking scope of the camera module 20 and the geometric center of the testing chart 10 is positioned in optical axis of the camera module 20. The camera module 20, configured to capture an image of the testing chart 10, includes a lens 21 and a voice coil motor 23 configured to drive the lens 21 to focus. During a focusing process of the camera module 20, according to a position of the geometric center of the polygon formed by the four marks 12 relative to the image sensing center of the camera module 20, the processor 30 calculates a horizontal offset of the voice coil motor 23.

The embodiments shown and described above are only examples. Many details are often found in the art such as the other features of a testing chart, camera module testing system and camera module testing method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A testing chart, for testing a camera module, comprising:
a scaleboard;
a testing pattern printed on the scaleboard; and
at least four marks distributed on the scaleboard, each quadrant of a rectangular coordinate system with an origin thereof meeting a geometric center of the testing chart being distributed with at least one of the marks.

2. The testing chart of claim 1, wherein the testing pattern is formed by a number of colored areas.

3. The testing chart of claim 2, wherein the colored areas are separated from the marks on the testing chart.

4. The testing chart of claim 2, wherein shapes of the marks are different from shapes of the colored areas.

5. The testing chart of claim 1, wherein the number of the marks is four, the marks are distributed along a polygon, and each mark meets a vertex of the polygon, and a geometric center of the polygon meets the geometric center of the testing chart.

6. A camera module testing method includes the following steps:
providing a testing chart, the testing chart comprising a scaleboard, a testing pattern printed on the scaleboard and at least four marks formed on the scaleboard, each quadrant of a rectangular coordinate system with an origin thereof meeting a geometric center of the testing chart being distributed with at least one of the marks;
providing a camera module, the camera module comprising a focusing lens and a voice coil motor configured to drive the focusing lens to move along an optical axis of the camera module;
positioning the testing chart at an object side of the camera module, and make the geometric center of the testing chart located in the optical axis of the camera module;
driving the focusing lens to capture images of the testing chart; and
providing a processor, during a focusing process of the camera module, according to a position of a polygon formed by the at least four marks relative to the image sensing center of the camera module, the processor calculating a horizontal offset of the voice coil motor.

7. The camera module testing method of claim 6, wherein the processor obtains a movement distance of the voice coil motor according to an image captured by the camera module.

8. The camera module testing method of claim 6, wherein the processor calculates the horizontal offset of the voice coil motor according to an offset of the geometric center of the polygon formed by the at least four marks relative to the image sensing center of the camera module.

9. The camera module testing method of claim 8, wherein the processor calculates a direction of the horizontal offset according to a direction of the offset of the geometric center of the polygon formed by the at least four marks relative to the image sensing center of the camera module,

10. A camera module testing system, for testing a camera module comprising a focusing lens and a voice coil motor configured to drive the lens to move along an optical axis of the camera module, comprising:
a testing chart, the testing chart comprising a scaleboard, a testing pattern printer on the scaleboard and at least four marks formed on the scaleboard, each quadrant of a rectangular coordinate system with an origin thereof meeting a geometric center of the testing chart being distributed with at least one of the marks, the testing chart being positioned at an object side of camera module, the voice coil motor driving the focusing lens to capture images of the testing chart; and
a processor, during a focusing process of the camera module, according to a position of the geometric center of the polygon formed by the at least four marks relative to the image sensing center of the camera module, the processor calculating a horizontal offset of the voice coil motor.
